(19) United States
(12) Patent Application Publication
(10) Pub. No.: US 2010/0169570 A1
(43) Pub. Date: Jul. 1, 2010

(54) Providing differentiated I/O services within a hardware storage controller

(76) Inventors: Michael Mesnier, Hillsboro, OR (US); David Koufaty, Portland, OR (US)

Correspondence Address: INTEL CORPORATION;c/o CPA Global, P.O. BOX 52050, MINNEAPOLIS, MN, 55402, US

(21) Appl. No.: 12/319,012

(22) Filed: Dec. 31, 2008

(51) Int. Cl. G06F 12/08

(52) U.S. Cl. 711/114; 711/E12.019

(57) ABSTRACT

A device, system, and method are disclosed. In one embodiment device includes routing logic that is capable of receiving an I/O storage request from an operating system. The I/O storage request includes an input/output (I/O) data type tag that specifies a type of I/O data to be stored with the I/O storage request. The routing logic is also capable of determining, based on the I/O data type tag, which of a number of storage pools to send the I/O storage request. Each storage pool has a certain level of associated service.

### FIELD OF THE INVENTION

The invention relates to providing differing quality of services to different I/O storage requests in a computer system.

### BACKGROUND OF THE INVENTION

Storage systems export a narrow I/O (input/output) interface, such as ATA (Advanced Technology Attachment) or SCSI (small computer system interface), whose access to data consists primarily of two commands: READ and WRITE. This block-based interface abstracts storage from higher-level constructs, such as applications, processes, threads, and files. Although this allows operating systems and storage systems to evolve independently, achieving end-to-end application Quality of Service (QoS) can be a difficult task.

### BRIEF DESCRIPTION OF THE DRAWINGS

The present invention is illustrated by way of example and is not limited by the drawings, in which like references indicate similar elements, and in which:

FIG. 1 illustrates an embodiment of a computer system and device capable of differentiating storage services per type of I/O in an I/O storage request.

FIG. 2 is a flow diagram of an embodiment of a process to provide differentiated storage services per type of I/O in an I/O storage request.

### DETAILED DESCRIPTION OF THE INVENTION

Embodiments of a device, system, and method to provide differentiated storage services per I/O storage request are disclosed.

In many embodiments, a QoS architecture for file and storage systems is described. The QoS architecture defines an operating system (OS) interface by which file systems can assign arbitrary policies (performance and/or reliability) to I/O streams, and it provides mechanisms that storage systems can use to enforce these policies. In many embodiments, the approach assumes that a stream identifier can be included in-band with each I/O request (e.g, using the Group Number field in the SCSI command set) and that the policy for each stream can be specified out-of-band through the management interface of the storage system.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

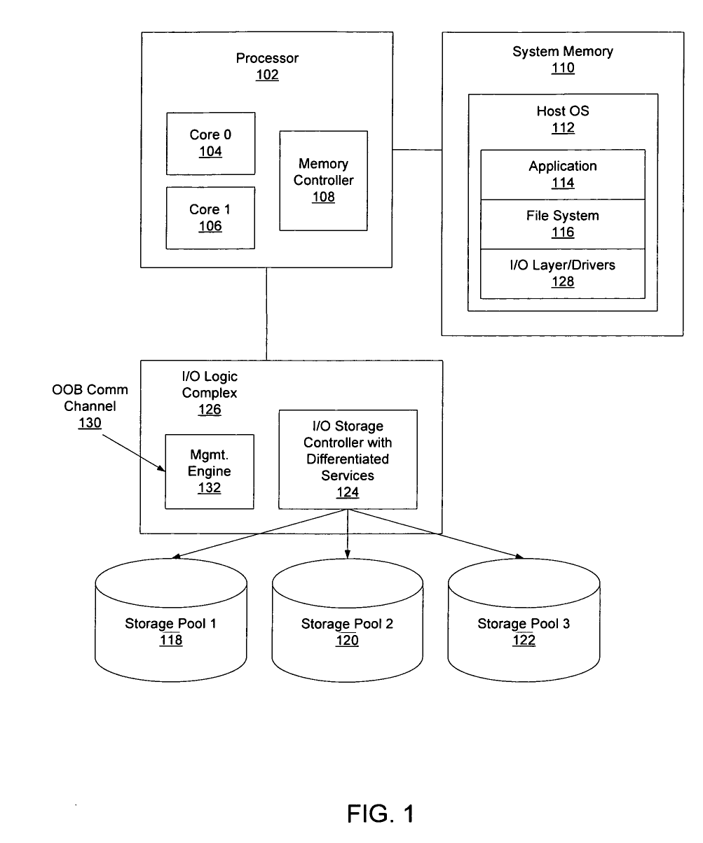

FIG. 1 illustrates an embodiment of a computer system and device capable of differentiating storage services per type of I/O in an I/O storage request. The computer system 100 may include a processor, such as processor 102. In other embodiments that are not shown, the computer system 100 may include two or more processors. Processor 102 may be an Intel®-based central processing unit (CPU) or another brand CPU. In different embodiments, processor 102 may have one or more cores. For example, FIG. 1 shows processor 102 with two cores: core 0 (104) and core 1 (106).

Processor 102 is coupled to a memory subsystem through memory controller 108. Although FIG. 1 shows memory controller 108 integrated into processor 102, in other embodiments that are not shown, the memory controller may be integrated into a bridge device or other device in the computer system that is discrete from processor 102. The memory subsystem includes system memory 110 to store instructions to be executed by the processor. The memory devices in the memory subsystem may be any type of volatile dynamic random access memory (DRAM), for example double data rate (DDR) synchronous DRAM, and/or any type of non-volatile memory, for example a form of Flash memory. The processor(s) is coupled to the memory by a processor-memory interface, which may be a link (i.e. an interconnect/bus) that includes individual lines that can transmit data, address, control, and other information between the processor(s) and the memory.

The host operating system (OS) 112 is representative of an operating system that would be loaded into the memory of the computer system 100 while the system is operational to provide general operational control over the system and any peripherals attached to the system. The host OS 112 may be a form of Microsoft® Windows®, UNIX, LINUX, or any other functional OS. The host OS 112 provides an environment in which one or more programs, services, or agents can run within. In many embodiments, one or more applications, such as application 114, is running on top of the host OS 112. The application may be any type of software application that performs one or more tasks while utilizing system resources. A file system 116 runs in conjunction with the host OS 112 to provide the specific structure for how files are stored in one or more storage mediums accessible to the host OS 112. In many embodiments, the file system 116 organizes files stored in the storage mediums on fixed-size blocks. For example, if the host OS 112 wants to access a particular file, the file system 116 can locate the file and specify that the file is stored on a specific set of blocks. In different embodiments, the file system 116 may be Linux Ext2, Linux Ext3, Microsoft® Windows® NTFS, or any other operational file system.

The host OS 112 utilizes the file system 116 to provide information as to the particular blocks necessary to access a file. Once the file system 116 has provided this block information related to a particular file, the request to access the actual storage medium may be made through a driver 128 in an I/O layer of the host OS 112. The I/O layer includes code to process the access request to the one or more blocks. In different embodiments, the driver may be implementing an I/O protocol such as a small computer system interface (SCSI) protocol, Internet SCSI protocol, serial advanced technology attachment (SATA) protocol, or another I/O protocol. The driver 128 processes the block request and sends the I/O storage request to a storage controller 124, which then proceeds to access a storage medium.

The storage mediums may be located within pools of storage, such as storage pools 118, 120, and 122. Storage mediums within the storage pools may include hard disk drives, large non-volatile memory banks, solid-state drives, tape drives, optical drives, and/or one or more additional types of storage mediums in different embodiments.

In many embodiments, a given storage pool may comprise a group of several individual storage devices of a single type. For example, storage pool 1 (118) may comprise a group of solid-state drives, storage pool 2 (120) may comprise a group of hard disk drives in a redundant array of independent disks (RAID) array, and storage pool 3 (122) may comprise a group of tape drives. In this example, storage pool 1 (118) may provide the highest storage quality of service because solid-state drives have better response times than standard hard disk drives or tape drives. Storage pool 2 (120) may provide a medium level of quality of service due to hard disk speed being slower than solid-state drive speed but faster than tape drive speed. Storage pool 3 (122) may provide a low level of quality of service due to the tape drive speed being the slowest of the three pools. In other embodiments, other types of storage mediums may be provided within one or more of the storage pools.

The host OS 112 or application 114 communicates with one or more of the storage mediums in the storage pools by having the driver 128 send the I/O storage request to the storage controller 124. The storage controller 124 provides a communication interface with the storage pools. In many embodiments, the storage controller 124 is aware of the level of service (i.e. performance) of each of the storage pools. Thus, from the example described above, the storage controller 124 is aware that storage pool 1 (118) provides a high level of service performance, storage pool 2 (120) provides a medium level of service performance, and storage pool 3 (122) provides a low level of service performance.

In some embodiments, the storage pools provide their respective quality of service information to the storage controller 124. In other embodiments, the storage controller actively stores a list that maps a certain quality of service to each storage pool. In yet other embodiments, the storage controller identify each available storage pool and determine each pool's quality of service level. The storage controller 124 may include performance monitoring logic that may monitor the performance (e.g. latency) of transactions to each pool and track a dynamic quality of service metric for each storage pool. In still yet other embodiments, an external entity such as an administrator may provide an I/O storage request routing policy that specifies the quality of service levels expected to be provided by each storage pool and which data types should be routed to each pool. Additionally, the administrator may provide this information through an out-of-band communication channel 130 that may be updated through a system management engine 132 located in the computer system and coupled to the storage controller 124. The system management engine may be a separate integrated circuit that can assist remote entities, such as a corporate information technology department, perform management tasks related to the computer system.

The storage controller may be integrated into an I/O logic complex 126. The I/O logic complex 126 may include other integrated controllers for managing portions of the I/O subsystem within the local computer system 200. The I/O logic complex 126 may be coupled to the host processor 102 through an interconnect (e.g. a bus interface) in some embodiments. In other embodiments that are not shown, the storage controller 124 may be discrete from the computer system 200 and the I/O logic complex may communicate with the host processor 102 and system memory 110 through a network (such as a wired or wireless network).

In many embodiments, I/O tagging logic is implemented in the file system 116. The I/O tagging logic can specify the type of I/O issued with each I/O storage request. For example, an I/O storage request sent to the storage controller 124 may include file data, directory data, or metadata. Each of these types of data may benefit from differing levels of service. For example, the metadata may be the most important type of data, the directory data may be the next most important type of data, and the file data may be the least important type of data. These levels of importance are modifiable and may change based on implementation. The levels of importance may coincide directly with the quality of service utilized in servicing each type of data. Additionally, in other embodiments, other types of data may be issued with the I/O storage requests. In any event, in embodiments where metadata, directory data, and file data comprise the three types of data to be issued, the file system 116 may include a tag with each block request that specifies the type of data as one of the three types listed. To accomplish this, the block I/O layer (file system layer) of the host OS 112 may be modified to add an I/O data type tag field to each logical block request to a disk. Thus, the tag may be passed to the driver 128 in the block I/O layer.

The driver 128 in the I/O layer of the host OS 112 will then append the I/O data type tag along with each I/O storage request sent to the storage controller 124. The specific disk request sent to the storage controller (i.e. a SCSI or ATA request) would include the I/O data type tag in a field. In some embodiments, the tag may be stored in reserved byte fields in the SCSI or ATA command structure (e.g. the SCSI block command includes reserved bytes that may be utilized to store the tag). In other embodiments, the standards bodies for each I/O protocol may formally add the tag as a field in one or more standard commands sent from the driver 128 to the storage controller 124.

The storage controller 124 includes logic to monitor the I/O data type tag field in each I/O storage request. The storage controller 124 may include logic to route the I/O command to a specific storage pool based on the value stored in the tag. The storage controller can essentially provide differentiated storage services per I/O storage request based on the level of importance of the type of data issued with the request. Thus, if the data is of high importance, the data may be routed to the highest quality of service storage pool and if the data is of little importance, the data may be routed to the lowest quality of service storage pool.

The storage controller 124 provides a mapping of a logical block address in the I/O storage request to a physical storage device address. Thus, based on the changeable location where the I/O storage request is routed using the I/O data type tag field, the storage controller provides a dynamic mapping service for I/O storage requests.

In some embodiments, the storage controller 124 is a RAID controller and the differentiated storage services based on I/O data type may be implemented as a new RAID level in the RAID storage system.

The storage controller 124 may include a modifiable mapping table that routing logic within the storage controller 124 may utilize to route each incoming I/O storage request from the driver 128 in the host OS 112 I/O layer to a specific storage pool with the desired quality of service level. In many embodiments, the quality of service level includes a performance metric, which determines that the quality of service is higher based on less storage latency. In other embodiments, the quality of service level includes a security metric, which determines that the quality of service is higher based on the relative security needed for the data (e.g. backup systems, privacy, etc.).

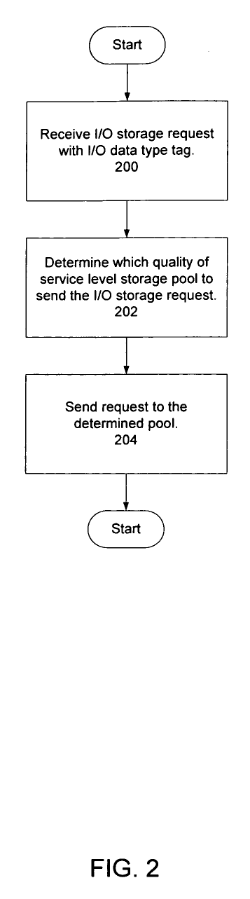

FIG. 2 is a flow diagram of an embodiment of a process to provide differentiated storage services per type of I/O in an I/O storage request. The process is performed by processing logic that may comprise hardware, software, or a combination of both. The process begins by processing logic receiving an I/O storage request with an I/O data type tag (processing block 200). The I/O data type tag specifies a type of data issued with the I/O storage request. In different embodiments, the type of data may be metadata, directory data, or file data.

Next, processing logic utilizes the I/O data type tag to determine which quality of service level the I/O storage request should receive (processing block 202). The quality of service level may be matched with the type of I/O issued with the I/O storage request. For example, if the type of I/O issued with the request is the most important type of I/O, the quality of service given to the I/O storage request may also be deemed to be the highest available.

In some embodiments, processing logic adds an additional quality of service tag to the request once the quality of service to be provided has been determined. The quality of service tag may be utilized when additional considerations are made to determine the quality of service beyond just the type of I/O data. For example, if the highest quality of service storage pool is being overutilized, the next best available quality of service storage pool may be utilized to store the I/O storage request even though the type of I/O data issued with the request may be sufficient to be categorized with the highest quality of service. In these embodiments, the extra quality of service tag may be utilized to further distinguish each I/O storage request.

Returning to FIG. 2, the process continues with processing logic then sending the I/O storage request to the storage pool that was determined (processing block 204) and the process is finished.

Thus, embodiments of a device, system, and method to provide differentiated storage services per I/O storage request are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A storage controller device, comprising:
routing logic to
receive an I/O storage request from an operating system, the I/O storage request including an input/output (I/O) data type tag specifying a type of I/O data to be stored with the I/O storage request;
determine, based on the I/O data type tag, which storage pool of a plurality of storage pools to send the I/O storage request, wherein each of the plurality of storage pools comprises at least one level of service.

2. The device of claim 1, wherein the routing logic is further operable to:
identify each available storage pool; and
determine the level of service offered by each available storage pool.

3. The device of claim 2, wherein the routing logic is further operable to:
determine the level of service desired for the I/O data type listed in the I/O data type tag; and
send the I/O storage request to a first storage pool of the plurality of storage pools, the first storage pool offering the determined level of service.

4. The device of claim 3, wherein the storage controller device comprises a redundant array of independent disks (RAID) controller.

5. The device of claim 4, wherein the I/O storage request further comprises an operating system generated logical block request.

6. The device of claim 5, wherein the routing logic is further operable to:
dynamically map the logical block request to a physical storage device within one of the plurality of storage pools, the physical storage device offering the desired level of service corresponding to the I/O data type tag in the I/O storage request.

7. The device of claim 1, wherein the routing logic is further operable to:
receive a first I/O storage request specifying a first type of I/O data;
receive a second I/O storage request specifying a second type of I/O data, wherein the first type of I/O data desires a higher quality of service than the second type of I/O data;
send the first I/O storage request to a first I/O storage pool; and
send the second I/O storage request to a second I/O storage pool, wherein the first I/O storage pool provides higher quality of I/O storage service than the second I/O storage pool.

8. The system of claim 1, wherein the I/O data type tag specifies data of one of file data, directory data, and metadata.

9. The system of claim 1, wherein the routing logic is further operable to:
receive a routing policy for each type of data to store; and
utilize the received routing policy to route each I/O storage request to at least one of the plurality of storage pools.

10. The system of claim 9, wherein the routing logic is further operable to receive the routing policy in an out-of-band communication channel.

11. A system, comprising:
a file system stored in a memory, the file system to provide an input/output (I/O) data type tag specifying a type of I/O data to store with an I/O storage request;
an operating system stored in the memory, the operating system to send the I/O storage request to a storage controller, the I/O storage request including the I/O data type tag as a field in the I/O storage request; and
the storage controller to:
receive the I/O storage request from the operating system;
determine, based on the I/O data type tag, which storage pool of a plurality of storage pools to send the I/O storage request, wherein each of the plurality of storage pools comprises at least one level of service.

12. The system of claim 11, wherein the storage controller is further operable to:
identify each available storage pool; and
determine the level of service offered by each available storage pool.

13. The system of claim 12, wherein the storage controller is further operable to:
determine the level of service desired for the I/O data type listed in the I/O data type tag; and
send the I/O storage request to a first storage pool of the plurality of storage pools, the first storage pool offering the determined level of service.

14. The system of claim 13, wherein the storage controller comprises a redundant array of independent disks (RAID) controller.

15. The system of claim 14, wherein the operating system is further operable to send the I/O storage request to the storage controller in the form of a logical block request.

16. The system of claim 15, wherein the storage controller is further operable to:
dynamically map the logical block request to a physical storage device within one of the available storage pools, the physical storage device offering the desired level of service corresponding to the I/O data type tag in the I/O storage request.

17. The system of claim 11, wherein the storage controller is further operable to:
receive a first I/O storage request specifying a first type of I/O data;
receive a second I/O storage request specifying a second type of I/O data, wherein the first type of I/O data desires a higher quality of service than the second type of I/O data;
send the first I/O storage request to a first I/O storage pool; and
send the second I/O storage request to a second I/O storage pool, wherein the first I/O storage pool provides higher quality of I/O storage service than the second I/O storage pool.

18. The system of claim 11, wherein the I/O data type tag specifies data of one of file data, directory data, and metadata.

19. The system of claim 11, wherein the storage controller is further operable to:
receive a routing policy for each type of data to store; and
utilize the received routing policy to route each I/O storage request to at least one of the plurality of storage pools.

20. The system of claim 19, wherein the storage controller is further operable to receive the routing policy in an out-of-band communication channel.

21. A method, comprising:
receiving an input/output (I/O) storage request, the I/O storage request including a tag specifying a type of I/O data to store;
determining, based on the I/O data type tag, which storage pool of a plurality of storage pools to send the I/O storage request, wherein each of the plurality of storage pools comprises a level of service.

22. The method of claim 21, further comprising:
determining the level of service desired for the I/O data type; and
including a quality of service tag with the I/O storage request based on the determination.

23. The method of claim 22, further comprising:
including the I/O data type tag in each logical disk request from an operating system block I/O layer.

24. The method of claim 22, further comprising:
receiving a first I/O storage request specifying a first type of I/O data;
receiving a second I/O storage request specifying a second type of I/O data, wherein the first type of I/O data desires a higher quality of service than the second type of I/O data;
sending the first I/O storage request to a first I/O storage pool; and
sending the second I/O storage request to a second I/O storage pool, wherein the first I/O storage pool provides higher quality of I/O storage service than the second I/O storage pool.
